(19) United States
(12) Patent Application Publication
(10) Pub. No.: US 2004/0161130 A1
(43) Pub. Date: Aug. 19, 2004

(54) Electroacoustic transducer, and electronic device using the same

(75) Inventor: Katsutoshi Suzuki, Fukushima-ken (JP)

Correspondence Address: BRINKS HOFER GILSON & LIONE, P.O. BOX 10395, CHICAGO, IL, 60610, US

(73) Assignee: Alps Electric Co., Ltd.

(21) Appl. No.: 10/776,890

(22) Filed: Feb. 10, 2004

(30) Foreign Application Priority Data
Feb. 12, 2003 (JP) 2003-033344

(51) Int. Cl. H04R 9/06; H04R 1/00; H04R 11/02

(52) U.S. Cl. 381/431; 381/412; 381/400; 381/398

(57) ABSTRACT

The present invention provides an electroacoustic transducer capable of removing non-uniformity of a gap between a coil and a magnet and of vibrating a diaphragm properly, and an electronic apparatus using the same. An electroacoustic transducer 1 of the present invention comprises a plane diaphragm 2 and a vibration-generating source 3 for vibrating the diaphragm 2, wherein the vibration-generating source 3 is supported in the vicinity of one end 2a on the backside of the diaphragm 2, at least the one end 2a and two sides 2b and 2b of the diaphragm 2, which are perpendicular to the one end 2a and are opposite to each other, are supported on an elastic cushion member 9, and wherein the diaphragm 2 is vibrated in a plane direction perpendicular to the plane of the diaphragm 2 when the vibration-generating source 3 is driven.

### BACKGROUND OF THE INVENTION

1. Field of the Invention

The present invention relates to an electroacoustic transducer, and more particularly to a thin film electroacoustic transducer using a plane diaphragm and to an electronic apparatus using the electroacoustic transducer.

2. Description of the Related Art

Conventionally, a thin film electroacoustic transducer has been employed as speakers or microphones used for a variety of electronic apparatuses, such as a notebook-type personal computer, a film-type televisions, and a mobile telephone.

Such a conventional electroacoustic transducer is provided with a plane diaphragm 51 made of a transparent material, such as acryl, as shown in FIG. 10.

A vibration-generating source 52 for vibrating the diaphragm 51 is provided in the vicinity of one end on the rear surface of the diaphragm 51 on the left side of the figure. The vibration-generating source 52 is provided with a magnet 53 composed of a permanent magnet opposite to the diaphragm 51 with a predetermined gap. The magnet 53 is fixed to a base 55 via a yoke 54.

The yoke 54 is formed in a ‘U’ shape in section view, a base portion 54a is fixed to the base 55 by means of an adhesive and the like, and a pair of arms 54b and 54b opposite to each other extends at a predetermined length from the base portion 54a toward the diaphragm 51.

Also, the magnet 53 is fixed to the central portion of the base portion 54a between the pair of arms 54b and 54b.

In addition, in the vicinity of the magnet 53, a coil 56 surrounding the outer peripheral surface of the magnet 53 and wound with its interior hollowed is fixed to the backside of the diaphragm 51. Furthermore, an elastic cushion member 57 having a sponge shape, for example, is mounted at the outer peripheral edge of the backside of the diaphragm 51, and the base 55 is mounted at the bottom of the cushion member 57.

Namely, the outer peripheral edge of the diaphragm 51 is supported on the cushion member 57, which is supported on the base 55, and the diaphragm 51 can be vibrated in a plane direction perpendicular to the plane of the diaphragm 51.

In assembling the conventional electroacoustic transducer as described above, first, the coil 56 is adhered at a position in the vicinity of the left end of the backside of the diaphragm 51 by means of an adhesive (not shown) and the like, and the cushion member 57 is also adhered to the outer peripheral edge of the backside of the diaphragm 51.

Next, the yoke 54, to which the magnet 53 has been fixed in advance by means of an adhesive and the like, is adhered at a predetermined position on the base 55 by means of an adhesive using a positioning tool.

Subsequently, the base 55 is adhered to the cushion member 56 such that the outer peripheral portion of the coil 56 does not come into contact with the arms 54b of the yoke 54, which is fixed to the base 55, while the transparent diaphragm 51 is confirmed via direct observation with the eyes.

In this way, a predetermined gap is formed between the magnet 53 fixed to the central portion of the base 54a of the yoke 54 and the inner peripheral surface of the coil 55.

In operation, in a case in which the conventional electroacoustic transducer assembled as described above is a speaker, when an alternating current, being an electrical signal converted from a sound signal, flows into the coil 56, a magnetic field is generated in the coil 56 and operates on the magnetic field of the magnet 53. As a result, a magnetic force, which vibrates the coil in the plane direction perpendicular to the plane of the diaphragm 51, is generated.

In synchronization with this magnetic force, the diaphragm 51 mounted on the cushion member 57 vibrates in the plane direction at a predetermined frequency, and a sound of a predetermined volume can be output from the diaphragm 51.

However, in the assembling of the conventional electroacoustic transducer, since the base 55 is adhered to the cushion member 56 such that the coil 56 does not come into contact with the arm 54b of the yoke 54 while the diaphragm 51 is confirmed via direct observation with the eyes, there is a problem in that much time is required for assembling, and the gap between the coil 56 and the arm 54b of the yoke 54 is not uniform. When the gap between the coil 56 and the arm 54b of the yoke 54 is not uniform, the strength of the magnetic field generated in the coil 56 is not uniform. Therefore, it may not be possible to increase the output of sound produced by the vibration of the diaphragm 51.

### SUMMARY OF THE INVENTION

The present invention is designed to solve the above problems, and it is an object of the present invention to provide an electroacoustic transducer that is capable of removing the non-uniformity of a gap between a coil and a magnet and of vibrating a diaphragm properly, and an electronic apparatus using the same.

In order to achieve the above object, according to a first aspect of the present invention, an electroacoustic transducer comprises a plane diaphragm and a vibration-generating source for vibrating the diaphragm, wherein the diaphragm supports the vibration-generating source in the vicinity of one end on the backside of the diaphragm, at least the one end and two sides of the diaphragm, which are perpendicular to the one end and are opposite to each other, are supported on an elastic cushion member, one side of the cushion member supports the base, and the other side thereof is supported on the base opposite to the diaphragm, and wherein the diaphragm is vibrated in a plane direction perpendicular to the plane of the diaphragm when the vibration-generating source is driven.

As a second solution for solving the above object, the vibration-generating source includes a magnet separated from the backside of the diaphragm by a predetermined gap, and a coil wound along the outer peripheral surface of the magnet so as to be separated from by a predetermined gap, wherein the coil is fixed to the backside of the diaphragm, the magnet is mounted on a first plate-shape yoke, the first yoke is supported on a connecting member fixed to the backside of the diaphragm, and a gap is formed between the first yoke and the base.

As a third solution for solving the above object, the magnet is formed in a horizontally long shape in parallel to the one end of the diaphragm, the coil is wound in the horizontally long shape along the outer peripheral surface of the magnet, and a portion of the first yoke projecting from both ends of the coil in a longitudinal direction is supported on the backside of the diaphragm by means of the connecting member.

As a fourth solution for solving the above object, the connecting member is formed of an elastic member.

As a fifth solution for solving the above object, a second yoke is stacked on the magnet on the side opposite to the backside of the diaphragm, and a gap is formed between the second yoke and the backside of the diaphragm.

As a sixth solution for solving the above object, the other end opposite to the one end of the diaphragm is supported on a rigid body.

As a seventh solution for solving the above object, push button switches are provided in the vicinity of the outer peripheral edge on the surface of the diaphragm.

As an eighth solution for solving the above object, an electronic apparatus comprises an electroacoustic transducer including a vibration-generating source for vibrating a diaphragm, and a body case for mounting the electroacoustic transducer, wherein the diaphragm is vibrated in a plane direction perpendicular to the diaphragm, and the body case is provided with a concave portion on which the electroacoustic transducer is mounted at a predetermined depth from the surface of the body case, and wherein, when the electroacoustic transducer is mounted in the concave portion, the outer peripheral edge of the base is guided into the bottom of the concave portion, and a predetermined gap is formed between the outer peripheral edge of the diaphragm and the inner peripheral surface of the concave portion.

As a ninth solution for solving the above object, the size of the base is formed to be larger than that of the diaphragm.

As a tenth solution for solving the above object, the base has the same size and shape as the diaphragm, and the concave portion comprised a first concave portion of a size to make the outer peripheral edge of the base guidable and a second concave portion formed to be larger than the first concave portion such that a predetermined gap is formed between the second concave portion and the outer peripheral edge of the diaphragm.

As an eleventh solution for solving the above object, the inner peripheral surface of the concave portion is formed in a tapered shape, the base is guided into the bottom of the concave portion, and a predetermined gap is formed between the outer peripheral edge of the diaphragm and the inner peripheral surface of the concave portion.

### BRIEF DESCRIPTION OF THE DRAWINGS

FIG. 1 is a view illustrating a first embodiment of an electroacoustic transducer according to the present invention;

FIG. 2 is a view illustrating the first embodiment of the electroacoustic transducer according to the present invention;

FIG. 3 is a view illustrating the first embodiment of the electroacoustic transducer according to the present invention;

FIG. 4 is a view illustrating a second embodiment of an electroacoustic transducer according to the present invention;

FIG. 5 is a view illustrating the second embodiment of the electroacoustic transducer according to the present invention;

FIG. 6 is a view illustrating an example of modification of the electroacoustic transducer according to the present invention;

FIG. 7 is a view illustrating a first embodiment of an electronic apparatus according to the present invention;

FIG. 8 is a view illustrating a second embodiment of the electronic apparatus according to the present invention;

FIG. 9 is a view illustrating a third embodiment of the electronic apparatus according to the present invention; and

FIG. 10 is a cross-sectional view for a main portion of a conventional electroacoustic transducer.

### DESCRIPTION OF THE PREFERRED EMBODIMENTS

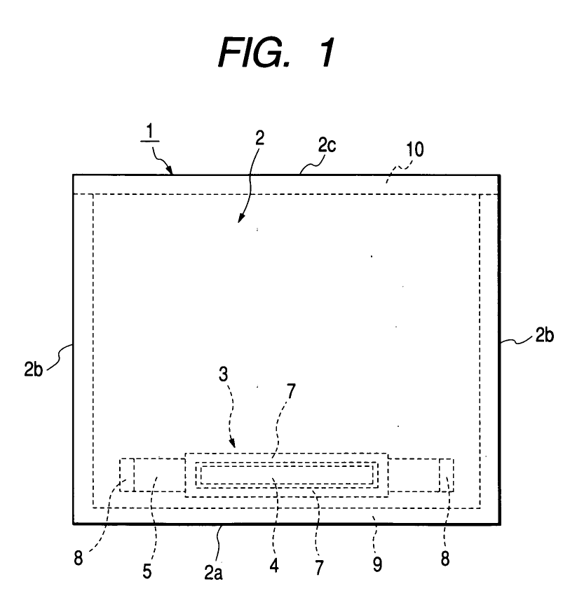

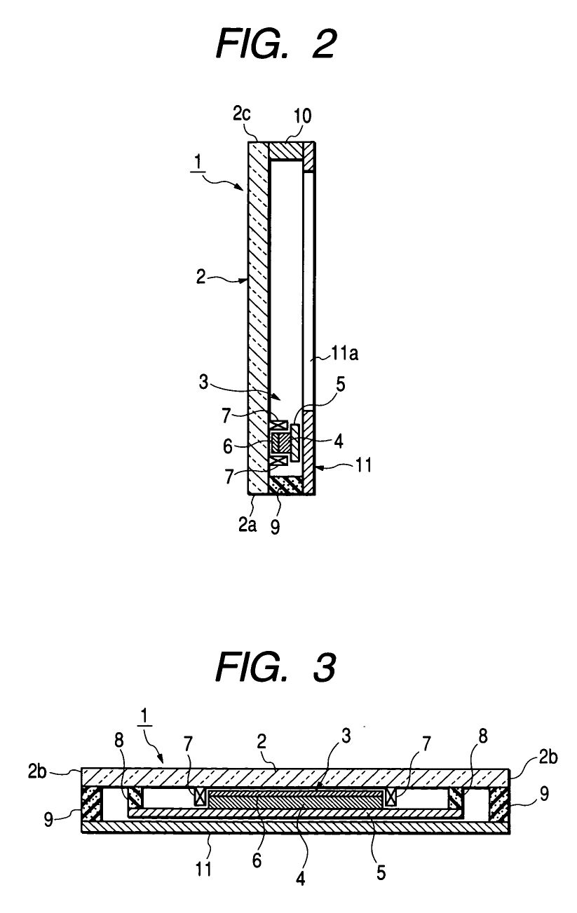

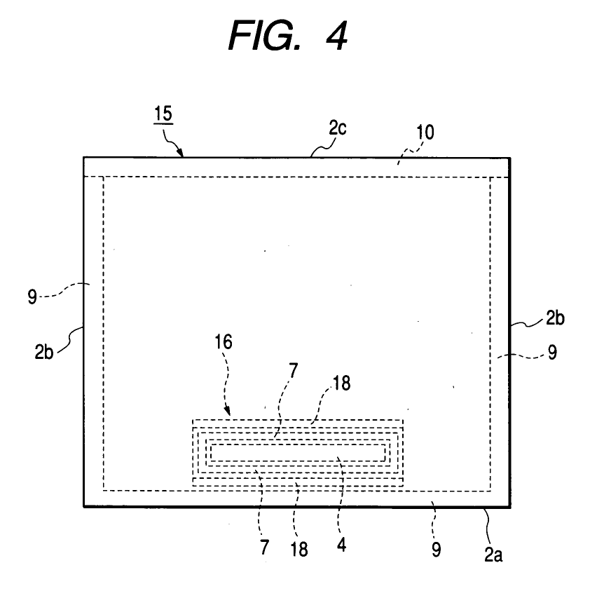

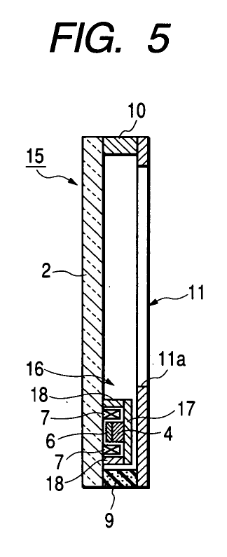

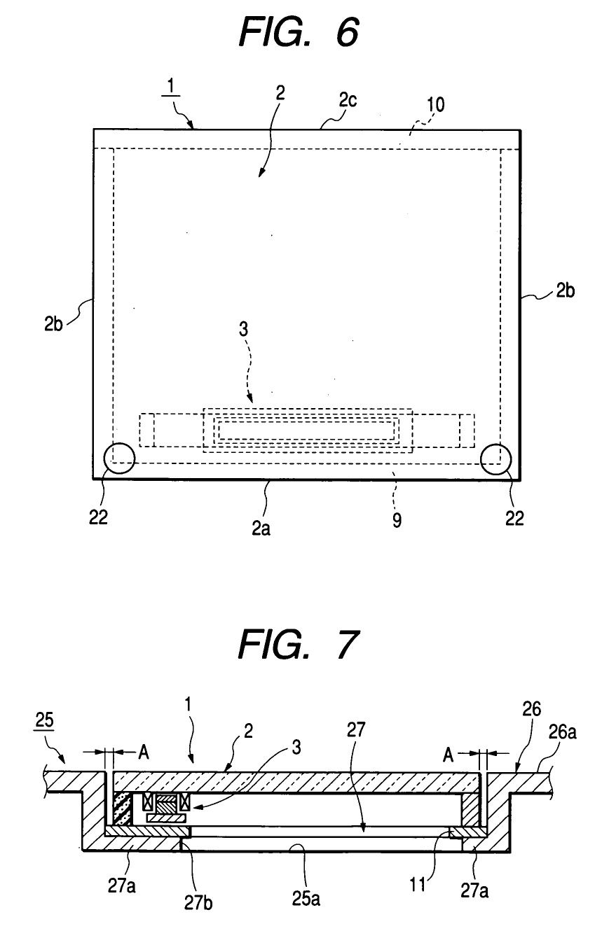

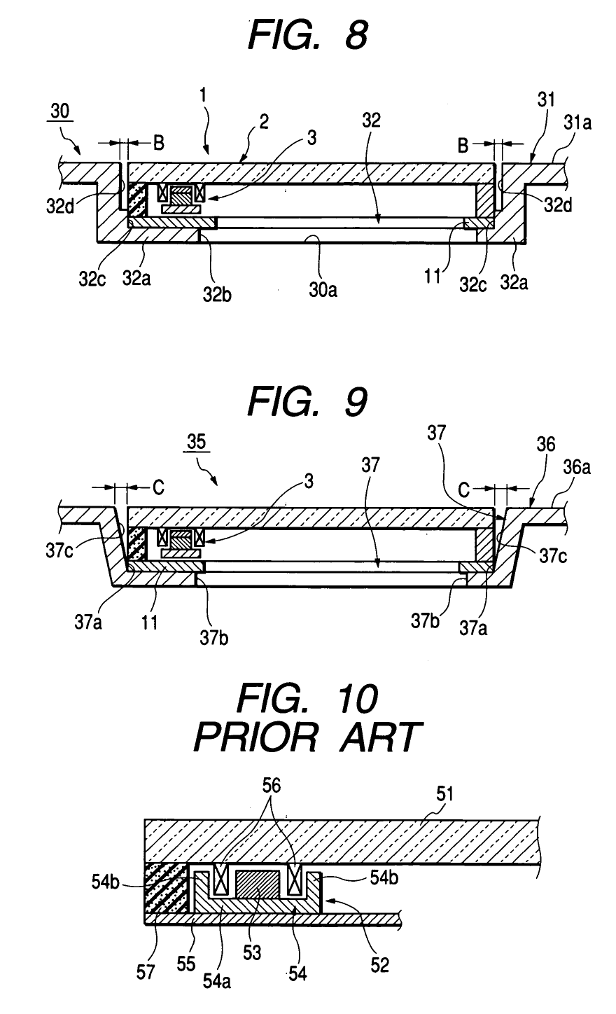

Now, preferred embodiments of an electroacoustic transducer according to the present invention will be described with reference to FIGS. 1 to 9. FIGS. 1 to 3 are views illustrating a first embodiment of an electroacoustic transducer according to the present invention, FIGS. 4 and 5 are views illustrating a second embodiment of the electroacoustic transducer according to the present invention, FIG. 6 is a view illustrating an example of modification of the electroacoustic transducer according to the present invention, FIG. 7 is a view illustrating a first embodiment of an electronic apparatus according to the present invention, FIG. 8 is a view illustrating a second embodiment of an electronic apparatus according to the present invention, and FIG. 9 is a view illustrating a third embodiment of an electronic apparatus according to the present invention.

To begin with, as shown in FIGS. 1 to 3, an electroacoustic transducer 1 according to the first embodiment of the present invention is provided at its uppermost portion with a diaphragm 2 that is composed of a transparent acryl plate and is formed in a substantially rectangular shape.

A vibration-generating source 3 for vibrating the diaphragm 2 is provided at the backside of the diaphragm 2 in the vicinity of its one end 2a on the front side.

The vibration-generating source 3 is provided with a magnet 4 composed of a permanent magnet with a predetermined gap between the magnet 4 and the backside of the diaphragm 2. The magnet 4 is formed of an elongated shape in parallel to the one end 2a of the diaphragm 2.

Also, the magnet 4 is mounted on a nearly central portion of a first plate-shape yoke 5, which is horizontally longer than the magnet 4, and is fixed by means of an adhesive, etc.

In addition, a second plate-shaped yoke 6 formed with the same size as the magnet 4 on a side opposite to the backside of the diaphragm 2 is fixed to the magnet 4, and a predetermined gap is formed between the second yoke 6 and the backside of the diaphragm 2.

Furthermore, the vibration-generating source 3 is provided with a coil 7 with a predetermined gap between the coil 7 and the outer peripheral surfaces of the magnet 4 and the second yoke 6. The coil 7 is fixed to the backside of the diaphragm 2 by means of an adhesive and the like.

Moreover, the first yoke 5, on which the magnet 4 is mounted and fixed, is supported on a connecting member 8 that is formed longer than the horizontal coil 7 and whose both ends extending outwardly beyond the horizontal direction of the coil 7 are fixed to the backside of the diaphragm 2.

Namely, the magnet 4 is mounted on the first plate-shape yoke 5 supported on a pair of connecting members 8, which is fixed to the backside of the diaphragm 2, and is provided on the side opposite to the backside of the diaphragm 2 with the second yoke 6 interposed therebetween. The connecting member 8 is made of the same material as a cushion member 9, for example, which will be described later.

In addition, a gap between the inner peripheral surface of the coil 7 and the outer peripheral surfaces of the magnet 4 and the second yoke 6 is formed to be about 0.2 mm, for example, and a predetermined gap is formed between the bottom of the coil 7 and the first yoke 5, as shown in FIG. 3.

Further, at least one end 2a and sides 2b and 2b of the diaphragm 2, which are opposite to each other in a direction perpendicular to the one end 2a, are supported on a cushion member 9 made of an elastic polyurethane foaming agent, etc., and the other end 2c opposite to the one end 2a is supported on a rigid body 10 made of a synthetic resin or metal.

Moreover, one sides of the cushion member 9 and the rigid body 10 support the diaphragm 2 and the other sides thereof are supported on a plate-shape base 11 opposite to the diaphragm 2.

In addition, the base 11 is formed with an opening 11a of a predetermined size. Further, dimensions in a height direction of the cushion member 9 and the rigid body 10 are formed to be larger than a dimension up to the first yoke 5 from the backside of the diaphragm 2, respectively.

For this reason, the first yoke 5, on which the magnet 4 and the second yoke 6 are mounted, remains suspended to the diaphragm 2 by the connecting member 8, with a predetermined gap formed between the first yoke 5 and the base 11.

In addition, a magnetic field of the magnet 4 operates on a magnetic field of the coil 7 produced when an alternating current flows into the coil 7, and therefore, the magnet 4 is vibrated in the plane direction perpendicular to the plane of the diaphragm 2, so that the diaphragm 2 can be vibrated in the plane direction.

In assembling the electroacoustic transducer 1 according to the first embodiment of the present invention as described above, first, the coil 7 is fixed to a position near the one end 2a of the backside of the diaphragm 2 by means of an adhesive and the like. Next, the magnet 4, to which the second yoke is fixed, and the pair of connecting members 8, respectively, are fixed at predetermined positions on the first yoke 5 by means of an adhesive and the like. Then, a predetermined gap gauge (not shown) is positioned so as to come into contact with the inner peripheral surface of the coil 7, and the magnet 4 and the second yoke 6 are inserted into the inner peripheral surface of the coil 7 with the gap gauge as a guider. As a result, the pair of connecting members 8 comes into contact with the backside of the diaphragm 2.

In this state, the connecting members 8 are adhered to the backside of the diaphragm 2 by means of an adhesive and the like. After that, when the gap gauge is removed, a uniform gap of about 0.2 mm is formed between the inner peripheral surface of the coil 7 and the outer peripheral surfaces of the magnet 4 and the second yoke 6. In addition, a predetermined gap is formed between the backside of the diaphragm 2 and the second yoke 6.

The cushion member 9 is adhered to the one end 2a and the sides 2b and 2b on the backside of the diaphragm 2 on which the vibration-generating source 3 is mounted on the backside, and the rigid body 10 is adhered to the backside of the other end 2c.

After that, when the base 11 is adhered to the cushion member 9 and the rigid body 10 on the basis of the rigid body 10, a predetermined gap is formed between the first yoke 5 and the base 11 to complete the assembly of the electroacoustic transducer 1 according to the first embodiment of the present invention.

For the electroacoustic transducer 1 according to the first embodiment, the vibration-generating source 3 can be assembled using a gap gauge (not shown) before the base 11 is mounted. For this reason, the gap between the magnet 4 and the second yoke 6, and the coil 7 can be uniformly formed, which results in a good assemblage, not by way of direct sight of the transparent diaphragm 2, as in the conventional technique.

In addition, since the other end 2c of the diaphragm 2 is supported on the rigid body 10, the base 11 can be mounted on the basis of the rigid body 10, and a positional error of the base 11 with respect to the diaphragm 2 can be removed. Thus, the opening 11a will not deviate from an opening 27c for exposing the liquid crystal panel 25a of the electronic apparatus 25 that will be described later.

In the operation of the electroacoustic transducer 1 according to the first embodiment of the present invention assembled as described above, first, a predetermined alternating current, being an electrical signal converted from a sound signal, flows into the coil 7 of the vibration-generating source 3.

Then, the magnetic field with predetermined energy is generated in the coil 7 and operates on the magnetic field of the magnet 4. Accordingly, the magnet 4 fixed to the first yoke 5 is vibrated in a direction (plane direction) perpendicular to the plane of the diaphragm 2.

As the magnet 4 is vibrated, the one end 2a of the diaphragm 2 is vibrated in the plane direction with the rigid body 10 of the other end 2c as a supporting point.

If the electroacoustic transducer 1 of the present invention is a speaker, the diaphragm 2 is vibrated in response to a sound signal and can output a sound with a predetermined frequency to the outside.

In addition, if the electroacoustic transducer 1 of the present invention is a microphone, when the diaphragm 2 is vibrated by a sound from the outside, the coil 7 is vibrated in synchronization with the vibration of the diaphragm 2. Accordingly, the induced electromotive force is generated in the coil 7.

A current, being an electrical signal generated by this induced electromotive force, is input as a sound signal.

In addition, an electroacoustic transducer 15 according to a second embodiment of the present invention will be described with reference to FIGS. 4 and 5. Herein, the same elements as those of the first embodiment are given to the same numerals as those of the first embodiment, but the detailed description thereof will be omitted for clarity of the description.

To begin with, the electroacoustic transducer 15 according to the second embodiment of the present invention is provided with a diaphragm 2, and a vibration-generating source 16 is mounted in the vicinity of one end 2a on the backside of the diaphragm 2. Of the vibration-generating source 16, a magnet 4 and a second yoke 6 are fixed to a first yoke 17 formed to be wider than the dimension of the width direction perpendicular to the longitudinal direction of a coil 7.

In addition, as shown in FIG. 5, the first yoke 17 of the vibration-generating source 16 is mounted on the backside of the diaphragm such that both ends of the first yoke 17 in the width direction, which are positioned on the outside of, the coil 7 is supported on a pair of connecting members 18 formed with almost the same horizontal length as the first yoke 17. Consequently, the vibration-generating source 16 remains suspended to the diaphragm 2.

Furthermore, the one end 2a, the sides 2b and 2b that is opposite to each other, and the other end 2c of the backside of the diaphragm 2 are supported on a cushion member 9 and a rigid body 10, which are supported on a base 11, as in the first embodiment.

Moreover, a predetermined gap is formed between the magnet 4 and the second yoke 6 and the inner peripheral surface of the coil 7, and between the outer peripheral surface of the coil 7 and the connecting member 18, respectively.

In assembling the electroacoustic transducer 15 according to the second embodiment constructed as above, the vibration-generating source 16 can be assembled before the base 11 is mounted, which results in a good assemblage, as in the first embodiment.

Therefore, the gap between the magnet 4 and the second yoke 6, and the coil 7 can be uniformly formed.

In addition, as shown in FIG. 6, an electroacoustic transducer 21, as an example of modification of the electroacoustic transducers 1 and 15 according to the first and second embodiments of the present invention, may be provided with push button switches 22 in the vicinity of the outer peripheral edge on the surface of the diaphragm 2. In the push button switch 22, although not shown, an elastic rubber member has, for example, a hollowed dome shape and is mounted on the surface of the diaphragm 2, and a movable contact point is formed on the zenith of the rubber member.

Furthermore, the movable contact point comes into contact with the surface of the diaphragm 2 on the side opposite to the movable contact point, thereby forming a conductible fixed contact point.

When the dome-shaped rubber member of the push button switch 22 is pushed, the movable contact point comes into contact with the fixed contact point such that the conduction between both points is achieved to make ON/OFF operation possible.

In the electroacoustic transducer 1 provided with the push button switches 22, by ON/OFF switching the push button switches 22, a menu selection and the like in an electronic device 25, for example, which will be described later, can be made.

Now, an electronic device of the present invention using the electroacoustic transducers 1 and 15 according to the first and second embodiments of the present invention will be described by way of an example of a portable telephone (not shown) and the like.

To begin with, as shown in FIG. 7, in an electroacoustic transducer 1 used for an electronic device 25 according to the first embodiment, the size of the base 11 is formed to be larger than that of the diaphragm 2, such that the outer peripheral edge of the base 11 is projected outwardly from the outer peripheral edge of the diaphragm 2.

In addition, the electronic device 25 composed of a portable telephone, etc., is provided with a body case 26 on which the electroacoustic transducer 1 can be mounted.

The body case 26 is provided with a concave portion 27 on which the electroacoustic transducer 1 can be mounted at a predetermined depth from the surface 26a of the body case 26.

An opening 27b for exposing a liquid crystal panel 25a of the electronic device 25 is formed in the bottom 27a of the concave portion 27. This opening 27b is opposite to an opening 11a of the base 11.

When the electroacoustic transducer 1 is mounted in the concave portion 27, the outer peripheral edge of the base part 11 is guided into the bottom of the concave portion 27, and a gap of a dimension of A is formed between the outer peripheral edge of the diaphragm 2 and the inner peripheral surface of the concave portion 27.

For this reason, the diaphragm 2 can be vibrated with high precision, without any obstruction of vibration of the diaphragm 2 in the inner peripheral surface of the concave portion 27.

In addition, in the electroacoustic transducer 1 mounted in the concave portion 27, since the diaphragm 2 has nearly the same height as the surface 26a of the body case 26, operator's fingers, etc., may be prevented from touching the diaphragm 2 by mistake when the diaphragm 2 is vibrated.

Furthermore, as shown in FIG. 8, in an electroacoustic transducer 1 used for an electronic device 30 according to a second embodiment of the present invention, the base 11 has the same size as the diaphragm 2.

Moreover, a concave portion 32, in which the electroacoustic transducer 1 can be mounted at a predetermined depth, is formed on the surface 31a of the body case 31 of the electronic device 30, and an opening 32b for exposing a liquid crystal panel 30a of the electronic device 30 is formed to be opened in the bottom 32a of the concave portion 32.

In addition, the concave portion 32 is formed of a two-stage shape, that is, a first concave 32c of a size to make the outer peripheral edge of the base 11 guidable, and a second concave portion 32d formed to be larger than the first concave 32c, with a gap of a dimension of B formed between the second concave portion 32d and the outer peripheral edge of the diaphragm 2.

In the electronic device 30 according to the second embodiment constructed as above, even if the diaphragm 2 is equal in size to the base 11, since the gap of the dimension of B is formed between the outer peripheral edge of the diaphragm 2 and the second concave portion 32d, the diaphragm 2 can be reliably vibrated.

Furthermore, in the electroacoustic transducer 1 mounted in the concave portion 32, since the diaphragm 2 has nearly the same height as the surface 32a of the body case 31, operator's fingers, etc., may be prevented from touching the diaphragm 2 by mistake when the diaphragm 2 is vibrated.

Moreover, an electronic device 35 according to a third embodiment of the present invention has a body case 36 that is provided with a concave portion 37 formed on the surface 36a of the body case 36 and in which the electroacoustic transducer 1 can be mounted at a predetermined depth.

An opening 37b is formed in the bottom 37a of the concave portion 37, and the inner peripheral surface 37c is formed in a tapered shape where the width increases from the bottom portion to the upper portion of the concave 37.

When the electroacoustic transducer 1 is mounted in the concave portion 37, the base 11 is guided into the bottom of the concave portion 37, and a gap of a dimension of C is formed between the outer peripheral edge of the diaphragm 2 and the inner peripheral surface 37c of the concave portion 37.

For this reason, the electronic apparatus 35 according to the third embodiment can accomplish the same effects as the electronic apparatuses 25 and 30 according to the first and second embodiments.

In addition, although the electroacoustic transducers 1 and 15 according to the first and second embodiments of the present invention, in which the other end 2c of the diaphragm 2 is supported on the rigid body 10, have been explained, the entire outer peripheral edge of the diaphragm 2 may be supported on the cushion member 9.

In other words, the vibration-generating source 3 may be supported on the backside of the diaphragm 2 in the vicinity of the one end 2a, and at least the one end 2a and the sides 2b and 2b, which is perpendicular to the one end 2a and is opposite to each other, may be supported on the elastic cushion-member 9.

By virtue of this support of the entire peripheral edge of the diaphragm 2 to the cushion member 9, the entire surface of the diaphragm 2 can be vibrated in the plane direction perpendicular to the plane of the diaphragm 2. If the electroacoustic transducer 1 is a speaker, a loud sound can be output.

In addition, although the electroacoustic transducers 1 and 15 according to the first and second embodiments of the present invention, in which the vibration-generating source 3 floats over the base 11 and is suspended to the diaphragm 2, have been explained, the magnet 53 may be fixed to the base 55 via the yoke 54, for example, as in the conventional technique as shown in FIG. 10.

In other words, even if the magnet 53 is fixed to the base 55 via the yoke 54 as in the conventional technique as shown in FIG. 10, by supporting the other end of the base 55 to a rigid body (not shown), the base 55 can be reliably positioned with respect to the diaphragm 51, and the gap between the magnet 53 and the coil 56 can be uniformly formed.

In addition, although the electroacoustic transducers 1 and 15 according to the first and second embodiments of the present invention, in which the vibration-generating sources 3 and 16 vibrate the diaphragm 2 using the magnetic field from the magnet and the coil, have been explained, a piezoelectric element (not shown) may be provided on the backside of the diaphragm 2, which may be vibrated by the piezoelectric element.

As described above, in the electroacoustic transducer according to the present invention, the vibration-generating source is supported on the backside of the diaphragm in the vicinity of the one end thereof, at least the one end and two sides of the diaphragm perpendicular to the one end and opposite to each other are supported on the elastic cushion member, and the cushion member is supported on the base of which one side is supported on the diaphragm and of which the other side is arranged on a side opposite to the diaphragm. In such a condition, since the diaphragm is vibrated in the plane direction perpendicular to the plane of the diaphragm when the vibration-generating source is driven, the diaphragm, of which at least the one end and the two sides are supported on the cushion member, can be reliably vibrated with high precision.

In addition, the magnet is mounted on the plate-shape first yoke, the first yoke is supported on the connecting member fixed to the backside of the diaphragm, and a gap is formed between the first yoke and the base. Therefore, the magnet and the first yoke can be assembled with them stacked on the diaphragm, and an electroacoustic transducer can be provided at low cost due to a good assemblage.

Furthermore, the gap between the coil and the magnet can be uniformly assembled.

Moreover, since a portion of the first yoke projecting from both ends in the horizontal direction of the coil is supported on the backside of the diaphragm by means of the connecting member, the vibration of the magnet is reliably transferred to the diaphragm through the connecting member, so that the diaphragm is vibrated.

In addition, since the connecting member is made of an elastic material, it can be formed of the same material as the cushion member, which results in the vibration of the diaphragm with more precision.

Furthermore, since the second yoke is stacked on the magnet on the side opposite to the backside of the diaphragm and a gap is formed between the second yoke and the backside of the diaphragm, the second yoke allows the magnetic field of the magnet to be bent to the coil and can increase the magnetic force of the magnet.

Moreover, the other end opposite to the one end of the diaphragm is supported on the rigid body. Therefore, when the base is mounted, it is mounted on the basis of the rigid body. Thus, an electroacoustic transducer can be easily assembled with high precision.

In addition, since the push button switches are provided in the vicinity of the outer peripheral end on the surface of the diaphragm, the menu input into a portable telephone, etc., can be easily achieved.

Furthermore, in the electronic devices of the present invention, when the electroacoustic transducer is mounted on the concave portion formed in the body case, the outer peripheral end of the base is guided in the bottom of the concave portion, and a predetermined gap is formed between the outer peripheral end of the diaphragm and the inner peripheral surface of the concave portion. Therefore, the outer peripheral end of the diaphragm and the inner peripheral surface of the concave portion do not come into contact with each other, and the diaphragm can be reliably vibrated.

Moreover, in the electroacoustic transducer mounted in the concave portion, since the diaphragm has nearly the same height as the surface of the body case, operator's fingers, etc., may be prevented from touching the diaphragm by mistake when the diaphragm is vibrated.

In addition, since the size of the base is formed to be larger than that of the diaphragm, the base can be reliably guided in the bottom of the concave portion, and a gap can be reliably formed between the outer peripheral end of the diaphragm and the inner peripheral surface of the concave portion.

Furthermore, the base has the same size as the diaphragm, and the concave portion is composed of a first concave portion of a size to make the outer peripheral end of the base guidable and a second concave portion formed to be larger than the first concave with a gap of a dimension of B formed between the second concave portion and the outer peripheral end of the diaphragm. Therefore, a gap can be reliably formed between the inner peripheral surface of the second concave portion and the diaphragm.

Moreover, the inner peripheral surface of the concave portion is formed of a tapered shape, the base is guided in the bottom of the concave portion, and a gap is formed between the outer peripheral end of the diaphragm and the inner peripheral surface of the concave portion. Therefore, the diaphragm can be vibrated with high precision without any contact between the outer peripheral end of the diaphragm and the inner peripheral surface of the concave portion.

What is claimed is:

1. An electroacoustic transducer comprising a plane diaphragm and a vibration-generating source for vibrating the diaphragm,
wherein the diaphragm supports the vibration-generating source in the vicinity of one end of the backside thereof, at least the one end and two sides of the diaphragm, which are perpendicular to the one end and are opposite to each other, are supported on an elastic cushion member, one side of the elastic cushion member supports the diaphragm, and the other side thereof is supported on the base opposite to the diaphragm, and
wherein the diaphragm is vibrated in a direction perpendicular to the plane of the diaphragm when the vibration-generating source is driven.

2. An electroacoustic transducer according to claim 1,
wherein the vibration-generating source includes a magnet separated from the backside of the diaphragm by a predetermined gap, and a coil wound along an outer peripheral surface of the magnet so as to be separated from the outer peripheral surface of the magnet by a predetermined gap,
wherein the coil is fixed to the backside of the diaphragm, the magnet is mounted on a first plate-shape yoke, the first yoke is supported on a connecting member fixed to the backside of the diaphragm, and a gap is formed between the first yoke and the base.

3. An electroacoustic transducer according to claim 2,
wherein the magnet is formed in a horizontally long shape in parallel to the one end of the diaphragm, the coil is wound in the horizontally long shape along the outer peripheral surface of the magnet, and a portion of the first yoke protruding from both ends of the coil in a longitudinal direction is supported on the backside of the diaphragm by the connecting member.

4. An electroacoustic transducer according to claim 2 or 3,
wherein the connecting member is formed of an elastic member.

5. An electroacoustic transducer according to claim 1,
wherein a second yoke is stacked on the magnet on the side opposite to the backside of the diaphragm, and a gap is formed between the second yoke and the backside of the diaphragm.

6. An electroacoustic transducer according to any one of claims 1 to 5,
wherein the other end opposite to the one end of the diaphragm is supported on a rigid body.

7. An electroacoustic transducer according to any one of claims 1 to 6,
wherein push button switches are provided in the vicinity of the outer peripheral edge on the surface of the diaphragm.

8. An electronic apparatus comprising an electroacoustic transducer including a vibration-generating source for vibrating a diaphragm, and a body case for mounting the electroacoustic transducer,
wherein the diaphragm is vibrated in a plane direction perpendicular to the diaphragm, and the body case is provided with a concave portion on which the electroacoustic transducer is mounted at a predetermined depth from the surface of the body case, and
wherein, when the electroacoustic transducer is mounted in the concave portion, the outer peripheral edge of the base is guided in the bottom of the concave portion, and a predetermined gap is formed between the outer peripheral edge of the diaphragm and the inner peripheral surface of the concave portion.

9. An electronic apparatus according to claim 8,
wherein the size of the base is formed to be larger than that of the diaphragm.

10. An electronic apparatus according to claim 8,
wherein the base has the same size and shape as the diaphragm, and the concave portion comprises a first concave portion of a size to make the outer peripheral edge of the base guidable and a second concave portion formed to be larger than the first concave such that a predetermined gap is formed between the second concave portion and the outer peripheral edge of the diaphragm.

11. An electronic apparatus according to claim 8,
wherein the inner peripheral surface of the concave portion is formed in a tapered shape, the base is guided in the bottom of the concave portion, and a predetermined gap is formed between the outer peripheral edge of the diaphragm and the inner peripheral surface of the concave portion.
